(19) United States
(12) Patent Application Publication
(10) Pub. No.: US 2026/0343706 A1
(43) Pub. Date: Oct. 29, 2026

(54) SMPS SERIES REGULATOR WITH ENERGY RECYCLE BACK TO THE SOURCE

(71) Applicant: SIGNIFY HOLDING B.V., EINDHOVEN (NL)

(72) Inventors: HAIMIN TAO, EINDHOVEN (NL); KARNEKUMAR ARULANDU, BREDA (NL)

(21) Appl. No.: 19/115,296

(22) PCT Filed: Sep. 13, 2023
(86) PCT No.: PCT/EP2023/075147

§ 371 Date: Mar. 26, 2025

(30) Foreign Application Priority Data
Sep. 27, 2022 (EP) 22197957.8

(51) Int. Cl. H05B 45/385; H05B 45/38

(52) U.S. Cl. CPC H05B 45/385; H05B 45/38

(57) ABSTRACT

The invention relates to a driver for powering a first load. The driver comprises a converter adapted to convert an alternating current, AC, voltage into a regulated voltage at an output of the converter referred to a reference, a first load stage, coupled to the output of the converter and adapted to receive the regulated voltage. The first load stage comprises a first node adapted to receive the regulated voltage and adapted to be couplable to the first load, a second node adapted to be couplable to the first load such that the first load is couplable between the first node and the second node, a first capacitor coupled between the second node and the reference, a first switched mode power supply having a first input coupled to the second node and having a first output coupled to a first output node, wherein the first switched mode power supply is adapted to regulate a current through the first load.

### FIELD OF THE INVENTION

The invention relates to a driver. The invention further relates to lighting system comprising the driver.

### BACKGROUND OF THE INVENTION

A high power factor single stage driver is often used in low cost products. When such a driver is used in a lighting system, the lighting load connected to the driver may suffer from flicker and a high Stroboscopic Visibility Measure, SVM. To overcome this problem, after the first stage another stage is introduced in the driver. The first stage may be used to provide power factor correction, PFC. The output of the first stage, as mentioned as above is not good for providing a high quality light output. The second stage receives the output of the first stage and regulates the current through the lighting load. The second stage may be designed in the form of a linear circuit, which is compact and cheap. The linear circuit however also introduces additional losses since the linear circuit dissipates the ripple that would otherwise be present across the lighting load. It is desired to provide a solution that provides a good reduction of flicker and SVM, in a cheap way while also reducing the energy losses in the driver.

### SUMMARY OF THE INVENTION

It is an objective of the invention to provide a driver that is more energy efficient, while also providing a good regulated current to the load.

To overcome this concern, in a first aspect of the invention, a driver for powering a first load is provided, the driver comprising:
a converter adapted to convert an alternating current, AC, voltage into a regulated voltage at an output of the converter referred to a reference;
a first load stage, coupled to the output of the converter and adapted to receive the regulated voltage, the first load stage comprising:
a first node adapted to receive the regulated voltage and adapted to be to the first load;
a second node adapted to be couplable to the first load such that the first load is couplable between the first node and the second node,
a first capacitor coupled between the second node and the reference;
a first switched mode power supply having a first input coupled to the second node and having a first output coupled to a first output node, wherein the first switched mode power supply is adapted to regulate a current through the first load.

The driver has a converter that converts an input voltage into a regulated voltage. the input voltage may be a fluctuating voltage such as an alternating current, AC, mains voltage. preferably, the regulated voltage is preferably a bus voltage that may be used to supply further stages of the driver. The driver has a first load stage that is coupled to the output of the converter. The first load stage is therefore coupled to the bus voltage and therefore receives the regulated voltage from the converter. The load stage has a first node that receives the regulated voltage. A second node is provided. The first load that is to be powered by the driver is coupled between the first node and the second node. A first capacitor is coupled between the second node and a ground reference. The ground reference is preferably the reference used by the converter and the first load stage. As an example, the reference may be considered a ground reference. The first load and the first capacitor are coupled in series between the regulated voltage and the reference. The first load stage has a first switched mode power supply, SMPS. The SMPS has a first input and a first output. The input is coupled to the second node. the first output is coupled to a first output node. The SMPS is further adapted to regulate the current through the first load.

The driver allows a good power factor to be achieved with the converter. The converter provides a voltage that is larger than the voltage needed by the first load. The first capacitor is coupled in series with the first load, and therefore the regulated voltage is equal to the voltage across the load and the first capacitor. It is desired to maintain the voltage as constant as possible. For example, when an LED load is coupled to the first loading stage, the voltage across the load will not fluctuate much. For an LED load it is therefore desired to regulate the current flowing through the LED load, since this has a direct relation to the light output. The input of the first SMPS may effectively be coupled in parallel with the first capacitor. Therefore, the voltage across the first capacitor is the voltage provided to the first input of the first SMPS. The voltage across the first capacitor requires some voltage needed for the first SMPS to operate. If the voltage across the first capacitor is too low, the first SMPS may not operate properly and the current through the first load may not be regulated properly. Therefore, the regulated voltage needs to be larger than the required first load voltage and the minimum needed headroom voltage across the first capacitor, i.e. the first input of the first SMPS. The first capacitor voltage may be provided to the converter so that the first SMPS can change the amplitude of the regulated voltage if needed using the measured capacitor voltage as a feedback signal. The voltage across the first capacitor may be regulated by the converter. The first SMPS is used to regulate the current through the first load. The energy that is taken from the first capacitor is provided to the first output of the first SMPS. Here, the power may be used in different ways as will be shown later on. Since the first SMPS only needs to convert the voltage across the first capacitor, which is a relatively low voltage, the first SMPS can use smaller and cheaper components. Since the energy outputted by the first SMPS can be re-used, at least partly, the driver becomes more energy efficient.

In a further example, the converter further comprises a rectifier circuit adapted to convert the AC voltage into a rectified voltage.

Preferably, a rectifier circuit is provided between the AC voltage and the converter. Preferably, the rectifier circuit is a full bridge rectifier. The rectifier circuit allows the AC voltage, preferably mains, to be rectified in an efficient manner.

In a further example, the converter is any of a buck converter, a boost converter, a buck-boost converter, a flyback converter or a resonant converter.

Preferably, the converter is any of a buck converter, a boost converter, a buck-boost converter, a flyback converter or a resonant converter. These types of converters allow a very energy efficient conversion of the AC voltage to the regulated voltage. A rectifier circuit can also easily be integrated in any of these converters.

Preferably, the converter has power factor correction function such that the input current waveshape stays close to a sinusoid and in phase with the mains voltage.

In further example, the driver further comprises a second load stage comprising:
a third node adapted to receive the regulated voltage and adapted to be couplable to a second load;
a fourth node adapted to be couplable to the second load such that the second load is couplable between the third node and the fourth node,
a second capacitor coupled between the fourth node and the reference;
a second switched mode power supply having a second input coupled to the fourth node and having a second output coupled to a second output node, wherein the second switched mode power supply is adapted to regulate a current through the second load.

Introducing a second loading stage having an identical lay-out as the first loading stage will provide additional advantages. Multiple loads can be coupled to the regulated voltage. Preferably, the regulated voltage is provided over a single line e.g. a voltage bus. Now two loads can be powered in a more efficient way. Another advantage is that the load voltages may differ from each other without affecting the total efficiency. In the situation where the first load stage and the second load stage are regulated by linear current regulators instead of using SMPSs, both linear current regulators would be dissipating excess power. In addition, for both linear current regulators to operate properly, the regulated voltage is equal to the largest voltage of both loads and the headroom needed for operating the linear current regulators. The linear current regulator regulating the current through the load with the lowest voltage has a higher headroom voltage and therefore additional power losses. Using SMPSs in the load stages makes the difference in load voltages almost irrelevant. For the SMPS regulating the current through the load with the lowest voltage, the input voltage for that SMPS will be larger. Since the SMPS does not operate in a dissipative way, the efficiency of the SMPS is hardly affected by any changes on the input. The efficiency of the SMPS regulating the current through the load with the largest voltage will have a slightly lower efficiency when the output node is coupled back to the first node due to a larger voltage conversion ratio between the SMPS's output and input as the SMPS regulating the current through the load with the lowest voltage. Since the SMPSs throughputs only a fraction of the load power, the overall efficiency remains high.

In a further example, the first output node is coupled to a further load.

The first output load can be coupled to a further load. This load may be a load requiring a small amount of energy such as a sensor, a wireless module or other circuitry part of the driver such as VCC supply voltage to the converter and/or the SMPSs.

In a further example, the first output node is further coupled to a bleeder circuit.

It may be that the further load is not capable of drawing enough power to allow the current through the first load to be regulated properly. Therefore, a bleeder circuit may be used next to the further load so that it is ensured that enough power is drawn at the first output node. Preferably, the bleeder circuit has a controllable bleeder so that the power that is dissipated by the bleeder can be regulated.

In a further example, the first output node is coupled to the first node.

The first output node of the SMPS can be coupled to the first node. This allows the first SMPS to provide energy back to the load, i.e. to the regulated voltage. This allows the power that is provided by the first SMPS to the first output node, for regulating the current through the first load, to be recycled back in an efficient way.

In a further example, the first switched mode power supply is a boost converter or a flyback converter and/or wherein the second switched mode power supply is a boost converter or a flyback converter.

Preferably, the first SMPS and the second SMPS are a boost converter or a flyback converter or any combination thereof. The boost converter topology allows a simple and efficient up transformation of the voltage across the capacitor to the voltage at the first output node. The flyback converter may provide an even more efficient up transformation because the flyback has a transformer of which the turn ratio can be adjusted to optimize the transformation.

In a further example, the driver comprises a controller for controlling the first switched mode power supply, wherein the controller is arranged to control the switched mode power supply for regulating a current through the first load.

Preferably, the driver has a controller. The controller may be used for controlling the first SMPS such that the current through the first load is regulated. The controller may also be used to control the second SMPS for regulating the current through the second load. The controller may also be used to control the converter to control the regulated voltage.

In a further example, the controller is part of the further load.

The controller can be part of the further load. The first SMPS then not only regulates the current through the first load but also provides power for operating the controller.

In another example, a lighting system is provided. The lighting system has the driver according to any of the preceding examples and the first load.

In another example, the first load is a semiconductor lighting load.

Preferably, the first load is a semiconductor lighting load. The semiconductor lighting load may be any of a light emitting diode, LED, laser diode or laser load. Preferably, the second load is also a semiconductor lighting load. The semiconductor lighting load may also be any of an LED, laser diode or laser load.

In another example, the lighting system comprises the second load.

In another example, the second load is a non-lighting load.

The second load may be a non-lighting load, such as a sensor for detecting presence. A typical application for a lighting system where a first load is a lighting load and a second load is a non-lighting load is a lighting system with e.g. presence detection. A driver is used to provide power to a lighting load, e.g. an LED lighting load, and also provide power to a sensor, e.g. a presence detector, for controlling the lighting load. This is type of driver is also referred to as a sensor-ready driver.

In another example a required operating voltage of the first load is different from a voltage required operating voltage of the second load.

The lighting system with the driver according to the previous examples allows different loads with different required voltages to be powered by a single converter in an energy efficient manner. The voltage differences are compensated by the first SMPS and the second SMPS. With a linear current regulator, the voltage would be present across the linear current regulator resulting in additional losses.

### BRIEF DESCRIPTION OF THE DRAWINGS

Examples of the invention will now be described with reference to the accompanying drawings, in which:

FIG. 1 shows an example of a driver according to the state of the art.

FIG. 2 shows an example of a driver for driving a load in an efficient way.

FIG. 3 shows another example of a driver for driving a load in an efficient way.

FIGS. 4a and 4b show examples of an SMPS.

FIGS. 5a and 5b show examples of an SMPS.

FIG. 6 shows another example a driver for driving a load in an efficient way.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should also be understood that the Figures are merely schematic and are not drawn to scale. It should also be understood that the same reference numerals are used throughout the Figures to indicate the same or similar parts.

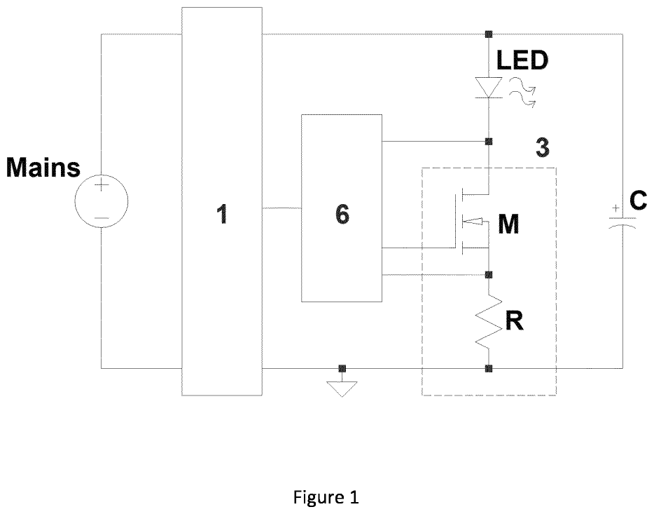

FIG. 1 shows an example of a driver according to the state of the art. A converter 1 is used to convert the alternating current, AC, voltage into a regulated voltage.

The regulated voltage is provided to a series circuit of a load LED and a linear current regulator 3. The regulated voltage is normally buffered by a buffer capacitor C. A controller 6 is used to sense the headroom across the linear current regulator 3. The controller 6 also senses the current flowing through the linear current regulator 3 using resistor R and therefore also through the load LED. The linear current regulator uses the sensed current for regulating the current through the load LED by controlling the gate of the linear switch M. The sensed headroom voltage is provided to the converter 1 to match the regulated volage amplitude to the required voltage for the load and the headroom of the linear current regulator 3. With the headroom of the linear current regulator 3, it is understood as the voltage across the linear current regulator 3. This voltage may not be too low as e.g. below 1 V because this causes the linear switch M to be unable to operate in its linear operating regime. The headroom voltage needs to be maintained within a bandwidth. If the headroom voltage is too low, the linear current regulator 3 does not operate properly. If the headroom voltage is too high, the losses in the linear current regulator 3 will increase. The controller 6 therefore needs to provide a feedback signal to the converter 1 to allow the regulated voltage, and therefore the headroom voltage to be regulated. Regardless of a good headroom voltage control, the linear current regulator 3 will always be relatively lossy. This is particularly true when there are multiple LED channels coupled to the same regulated voltage each with a linear regulator. The LED load with a lower voltage will result in higher voltage across that linear regulator and thus leads to more power dissipation. It is desired to provide a solution that reduces the power losses.

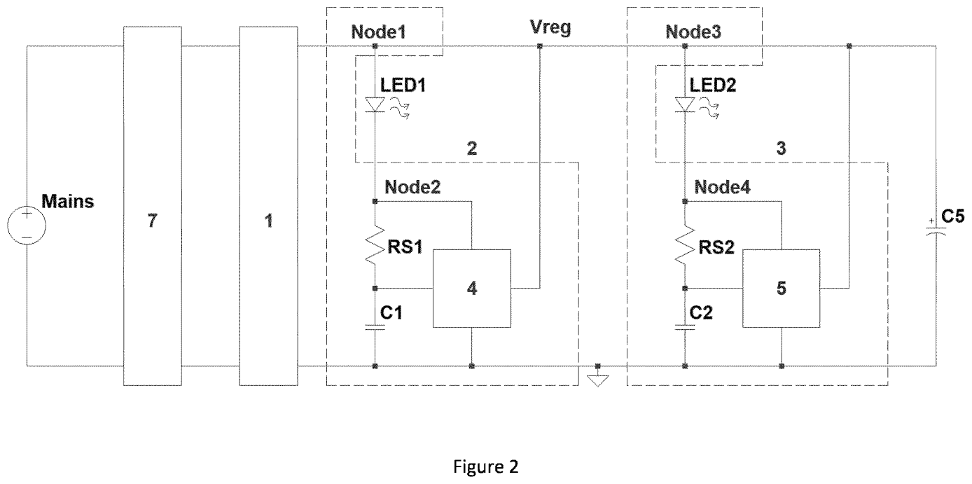

FIG. 2 shows an example of a driver that provides an improved power efficiency.

The driver has a converter 1 that converts an AC voltage into a regulated voltage Vreg. The AC voltage may be any AC type of voltage and is preferably a mains voltage, of which e.g. 230 V at 50 Hz and 120 V at 60 Hz are commonly used voltages. Preferably, the converter 1 performs power factor correction, PFC, for the AC voltage. An electromagnetic interference, EMI, filter 7 may be provided at the input of the converter 1.

Preferably, the regulated voltage Vreg is buffered by a buffer capacitor C5. This regulated voltage Vreg is provided to a first node Node1 of a first load stage 2. The first node Node1 therefore receives the regulated voltage Vreg. The first node Node1 is also coupled to a first load LED1. The first load stage 2 further has a second node Node2. The first load LED1 is also coupled to the second node Node2. The first load LED1 is therefore effectively coupled between the first node Node1 and the second node Node2.

Between the second node Node2 and a reference, a first capacitor C1 is placed. The reference is preferably the ground reference used for the direct current, DC, part of the driver circuit.

The first load stage 2 has a first switched mode power supply, SMPS, 4. The second node Node2 is coupled to a first input In1 of the first SMPS 4. The first SMPS 4 has an output coupled to a first output node Out1. The first SMPS 4 is used to regulate the current through the first load LED1. The first capacitor C1 is effectively coupled at the input of the first SMPS 4. The current through the first load LED1 may be regulated by sensing the current flowing through the first load LED1. This may be done by using a first current sensor RS1. The sensed current may be provided to the first SMPS 4 as a feedback signal. By controlling the current through the first load LED1, the voltage across the first capacitor C1 is automatically controlled. The voltage across the first capacitor C1 is effectively the regulated voltage Vreg minus the voltage required for the first load LED1. This would represent the headroom voltage in the linear current regulator topology. Since there is no resistive path in the first load stage 2, through which the load current will flow through, no additional power losses are introduced. In fact, instead of using a capacitor C1 and the first SMPS 4, an energy efficient solution is provided. Additionally, since the first SMPS 4 only converters a fraction of the total power, represented by the voltage across the first capacitor C1, the first SMPS 4 can be designed as a very small SMPS. In the example provided, the first output node Out1 of the first SMPS 4 is coupled to the first node Node1, effectively coupling the first output node Out1 of the first SMPS 4 to the regulated voltage Vreg.

In the example provided, a second load stage 3 is also coupled to the regulated voltage Vreg. The regulated voltage Vreg is provided to the third node Node3 of the second load stage 3. The third node Node3 is also coupled to a second load LED2. The second load stage 3 further has a fourth node Node4. The second load LED2 is also coupled to the fourth node Node4. The second load LED2 is therefore effectively coupled between the third node Node3 and the fourth node Node4.

Between the fourth node Node4 and the reference, a second capacitor C2 is placed. The reference is preferably the ground reference used for the direct current, DC, part of the driver circuit, similar to that used with the first load stage 2.

The second load stage 3 has a second switched mode power supply, SMPS, 5. The fourth node Node4 is coupled to a second input In2 of the second SMPS 5. The second SMPS 5 has an output coupled to a second output node Out2. The second SMPS 5 is used to regulate the current through the second load LED2. The second capacitor C2 is effectively coupled at the input of the second SMPS 5. The current through the second load LED2 may be regulated by sensing the current flowing through the second load LED2. This may be done by using a second current sensor RS2. The sensed current may be provided to the second SMPS 5 as a feedback signal. By controlling the current through the second load LED2, the voltage across the second capacitor C2 is automatically controlled. The voltage across the second capacitor C2 is effectively the regulated voltage Vreg minus the voltage required for the second load LED2. Since there is no resistive path in the first load stage 2, through which the load current will flow through, no additional power losses are introduced.

In the example provided, the second output node Out2 of the second SMPS 5 is coupled to the first third node Node3, effectively coupling the second output node Out2 of the second SMPS 5 to the regulated voltage Vreg.

It becomes clear from the description that the first load stage 2 and the second load stage 3 may be exactly the same in design. It is however to be understood that the designs may be different from each other.

Combining a first load stage 2 and a second load stage 3 as described in the examples allows the load voltages to be different from each other without severely providing additional losses. Instead, the voltage across the first capacitor C1 and the voltage across the second capacitor C2 will be regulated to different voltage levels by the first SMPS 4 and the second SMPS 5 respectively.

Since the voltages across the first capacitor C1 and the second capacitor C2 can be regulated independently and efficiently, the regulated voltage Vreg may be regulated in a simpler way. The regulated voltage Vreg may be set at a fixed voltage high enough to provide the voltage for the load requiring the largest voltage. The converter 1 therefore only needs to regulate the regulated voltage Vreg to a single level.

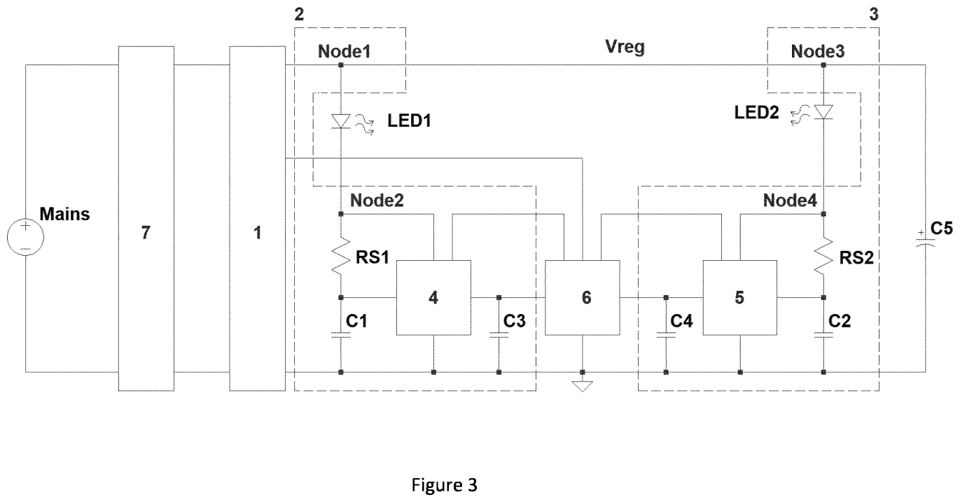

FIG. 3 shows another example of a driver. The driver may have a converter 1 according to the examples provided in FIG. 2. The driver may also have the first load stage 2 and the second load stage 3 according to the examples provided in FIG. 2. The first output node Out1 of the first SMPS 4 and the second output node Out2 of the second SMPS 5 are not coupled to the regulated voltage Vreg. Instead, they are both coupled to a further load. The voltage at the first output node Node1 and the voltage at the second output node Node 2 may be buffered by buffer capacitors C3 and C4 respectively, or by a same capacitor. The further load receives power from the first SMPS 4 via the first output node Out1 and power from the second SMPS 5 via the second output node Out2. The power that is drawn from the input of the first SMPS 4 and the second SMPS 5 for regulating the current through the first load LED1 and the second load LED2 respectively may be provided to the further load. In the situation that the further load is not capable of consuming all the power provided by the SMPSs, an additional bleeder may be introduced to dissipate the excess amount of power. The further load may for example be a sensor or any type of load requiring a significant lower amount of power compared to the first load LED1 and/or the second load LED2. Preferably, the further load is a controller 6. The controller may be used to control the driver. The controller 6 may be used to control the first SMPS 4, the second SMPS 5 and the converter 1 or any combination thereof. The further load may also have a wireless communication module. The wireless communication module may provide information to the controller 6 on the amount of current that is to be provided to any of the loads.

In the examples provided both SMPSs provide power to the further load. It is to be understood that only one SMPS may be needed to provide power to the further load. The other SMPS may then be coupled to the regulated voltage Vreg.

It is also to be understood that the second load stage 3 and second load LED2 are omitted. The first SMPS 4 may then be configured to provide the power to the further load.

In the examples provided, the first load LED1 and the second load LED2 are represented as light emitting diodes. The loads may also be any other type of load that requires a regulated current or voltage. When the load is a lighting load, preferably a semiconductor lighting load, the load may be an LED, laser diode or a laser load. When the load is a non-lighting load, the load may be for example a sensor for e.g. sensing presence or any environmental parameter, preferably a load that requires a constant current to operate.

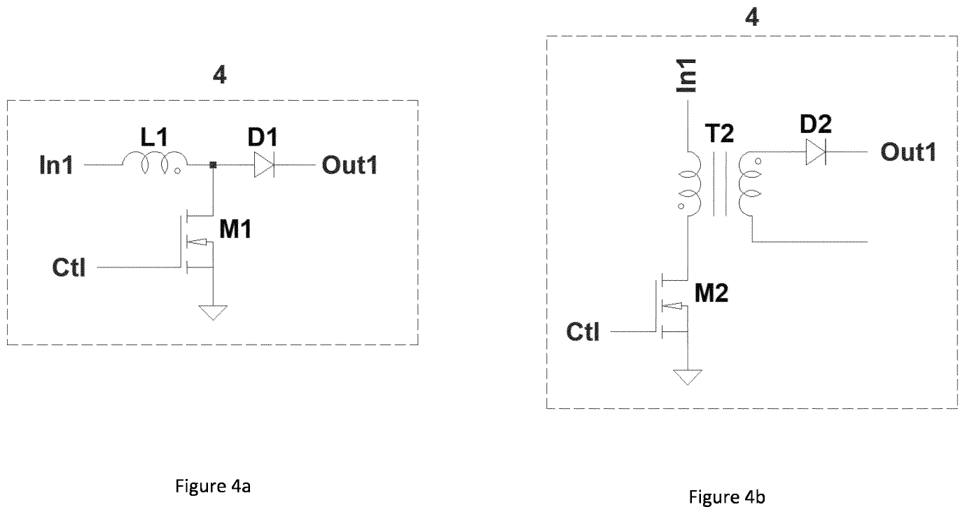

FIG. 4a shows an example of a first SMPS 4. In this example, the first SMPS 4 is designed as a boost converter. The boost converter has an inductor L1, a switch M1 and a diode D1 configured to provide a voltage at the first output node Out1 that is larger than the voltage at the first input In1. The switch M1 is controlled, preferably by the controller 6, to regulate the input voltage of the first SMPS 4. The switch M1 may be controlled by applying a pulse width modulated signal at the gate of the switch M1. The use of a boost converter may be especially beneficial when the first output node Out1 is coupled to the regulated voltage Vreg, which is always larger than the voltage at the input of the first SMPS 4.

FIG. 4b shows another example of a first SMPS 4. In this example, the first SMPS 4 is designed as a flyback converter. The flyback converter has a transformer T2 where the primary winding of the transformer T2 is coupled to a switch M2. The switch M2 is further coupled to the ground reference. The transformer T2 has a secondary winding that is coupled to the first output node Out1 via a diode D2. The switch M2 may be controlled, preferably by the controller 6, by applying a pulse width modulated signal at the gate of the switch M2. The turn ratio between the primary winding and the secondary winding of the transformer T2 may be used to optimize the transformation of the voltage at the first input In1 to the voltage at the first output node Out1. Therefore, a larger voltage difference between the voltage at the first input In1 and the voltage at the first output node Out1 can be transformed in a more energy efficient way.

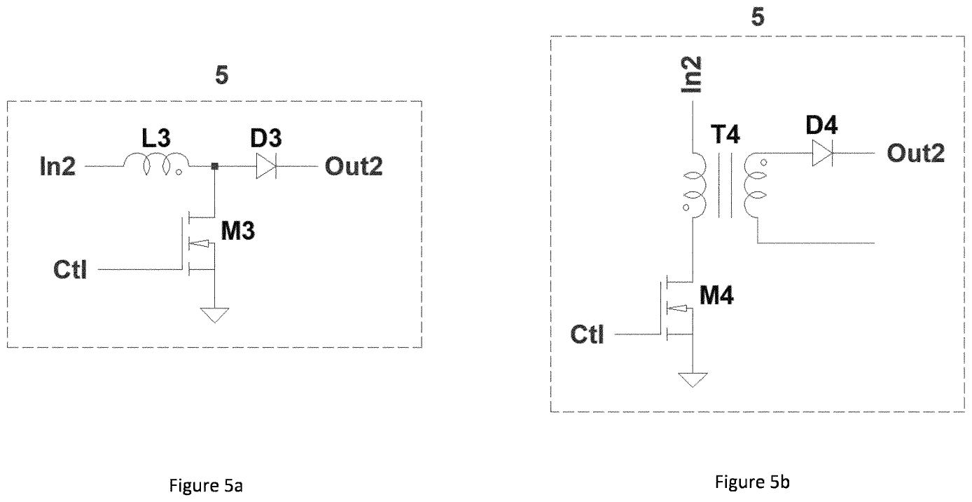

FIG. 5a shows an example of a second SMPS 5. In this example, the second SMPS 5 is designed as a boost converter. The boost converter has an inductor L3, a switch M3 and a diode D3 configured to provide a voltage at the second output node Out2 that is larger than the voltage at the second input In2. The switch M3 is controlled, preferably by the controller 6, to regulate the input voltage of the second SMPS 5. The switch M3 may be controlled by applying a pulse width modulated signal at the gate of the switch M3. The use of a boost converter may be especially beneficial when the second output node Out2 is coupled to the regulated voltage Vreg, which is always larger than the voltage at the input of the second SMPS 5.

FIG. 5b shows another example of a second SMPS 5. In this example, the second SMPS 5 is designed as a flyback converter. The flyback converter has a transformer T4 where the primary winding of the transformer T4 is coupled to a switch M4. The switch M4 is further coupled to the ground reference. The transformer T4 has a secondary winding that is coupled to the second output node Out2 via a diode D4. The switch M4 may be controlled, preferably by the controller 6, by applying a pulse width modulated signal at the gate of the switch M4. The turn ratio between the primary winding and the secondary winding of the transformer T4 may be used to optimize the transformation of the voltage at the second input In2 to the voltage at the second output node Out2. Therefore, a larger voltage difference between the voltage at the second input In2 and the voltage at the second output node Out2 can be transformed in a more energy efficient way.

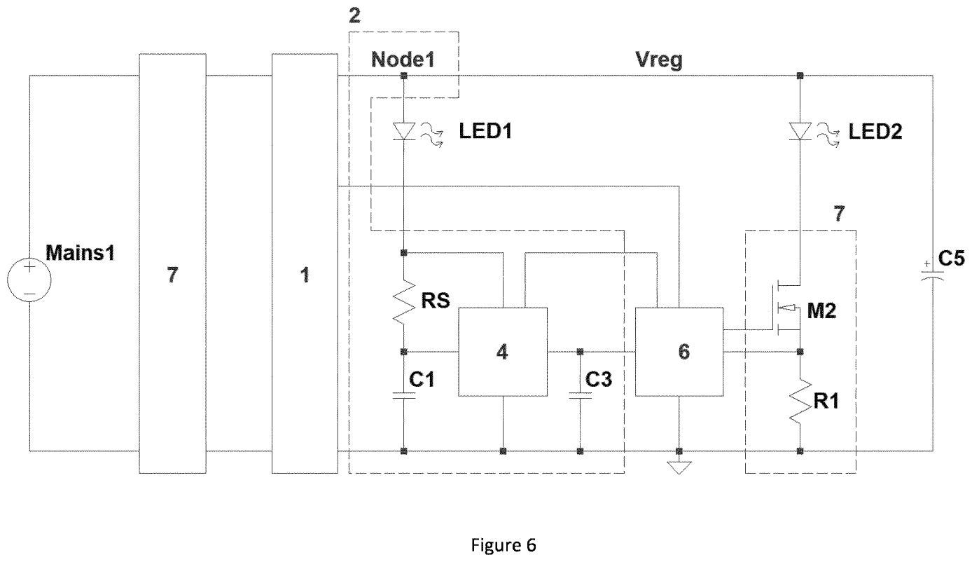

FIG. 6 shows an example of another driver. In this example, similar as to the examples provided in FIGS. 2 and 3, a converter 1 is used to convert the AC voltage into the regulated voltage Vreg. In this example, the first load stage 2 is similar to the first load stage 2 as shown in FIG. 3. The first SMPS 4 may be used to provide power to the controller 6. Alternatively, the power can also be provided to the regulated voltage Vreg, i.e. the first node Node1. Instead of using a second load stage 5 as disclosed in the examples shown in FIGS. 2 and 3, a linear current regulator 7 can be used. In this example, it is desired that the voltage required for the second load LED2 is larger than the voltage required for the first load LED1 to provide the most energy efficient solution for at least the linear current regulator 7. To further optimize the efficiency, the controller 6 may be used to control the converter 1 to regulate the regulated voltage Vreg to a voltage level close to the voltage required for the second load LED2 plus the headroom voltage required for the linear current regulator 7.

In the examples provided, the controller 6 may be used for controlling the first SMPS 4, the second SMPS 5. Additionally, the controller 6 may also be used to provide a control parameter or additional information to the converter 1.

Preferably, the driver is part of a lighting system. the lighting system may be a luminaire or a retrofittable lamp. The lighting system may also have the first load LED1 and/or the second load LED2. Preferably at least one the loads is a lighting load such as an LED load, a laser diode load or a laser load. One of the loads may also be a non-lighting load, allowing the luminaire to perform more functions than only providing general illumination. Preferably, if two or more loads are used, the required load voltages for each load may be different from the other required load voltages.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A driver for powering a first load, the driver comprising:
a converter adapted to convert an alternating current, AC, voltage into a regulated voltage at an output of the converter referred to a reference;
a first load stage, coupled to the output of the converter and adapted to receive the regulated voltage, the first load stage comprising:
a first node adapted to receive the regulated voltage and adapted to be couplable to the first load;
a second node adapted to be couplable to the first load such that the first load is couplable between the first node and the second node,
a first capacitor coupled between the second node and the reference; and
a first switched mode power supply having a first input coupled to the second node and having a first output coupled to a first output node, wherein the first switched mode power supply is adapted to regulate a current through the first load,
wherein the first switched mode power supply is a flyback converter.

2. The driver according to claim 1, wherein the converter further comprises a rectifier circuit adapted to convert the AC voltage into a rectified voltage.

3. The driver according to claim 1, wherein the converter is any of a buck converter, a boost converter, a buck-boost converter, a flyback converter or a resonant converter.

4. The driver according to claim 1, further comprising a second load stage comprising:
a third node adapted to receive the regulated voltage and adapted to be couplable to a second load;
a fourth node adapted to be couplable to the second load such that the second load is couplable between the third node and the fourth node,
a second capacitor coupled between the fourth node and the reference; and
a second switched mode power supply having a second input coupled to the fourth node and having a second output coupled to a second output node, wherein the second switched mode power supply is adapted to regulate a current through the second load.

5. The driver according to claim 1, wherein the first output node is coupled to a further load.

6. The driver according to claim 5, wherein the first output node is further coupled to a bleeder circuit.

7. The driver according to claim 1, wherein the first output node is coupled to the first node.

8. The driver according to claim 7, wherein the second switched mode power supply is a boost converter or a flyback converter.

9. The driver according to claim 1, further comprising a controller for controlling the first switched mode power supply, wherein the controller is arranged to control the first switched mode power supply for regulating a current through the first load.

10. The driver according to claim 9, wherein the controller is part of the further load.

11. A lighting system comprising the driver according to claim 1 and the first load.

12. The lighting system according to claim 11, wherein the first load is a semiconductor lighting load.

13. The lighting system according to claim 11.

14. The lighting system according to claim 13, wherein the second load is a non-lighting load.

15. The lighting system according to claim 13, wherein a required operating voltage of the first load is different from a voltage required operating voltage of the second load.
